(19) United States
(12) Patent Application Publication
(10) Pub. No.: US 2015/0047619 A1
(43) Pub. Date: Feb. 19, 2015

(54) EXHAUST GAS RADIATOR

(71) Applicant: Mahle International GmbH, Stuttgart (DE)

(72) Inventors: Tobias Fetzer, Ostfildern (DE); Boris Kerler, Stuttgart (DE); Lisa Von Rabenau, Frankfurt (DE)

(73) Assignee: Mahle International GmbH, Stuttgart (DE)

(21) Appl. No.: 14/388,694

(22) PCT Filed: Mar. 27, 2013
(86) PCT No.: PCT/EP2013/056542

§ 371 Date: Sep. 26, 2014

(30) Foreign Application Priority Data
Mar. 28, 2012 (DE) 102012205026.4
May 24, 2012 (DE) 102012208742.7

(51) Int. Cl. F02M 25/07; F28D 1/053; F28D 1/04

(52) U.S. Cl. CPC F02M 25/0734; F28D 1/0417; F28D 1/053
USPC 123/568.12; 165/143; 165/159

(57) ABSTRACT

An exhaust gas radiator for at least one of an exhaust gas system and an exhaust gas recirculation system of an internal combustion engine may include an exhaust gas path, which leads from an exhaust gas inlet to an exhaust gas outlet, and a coolant path, which is coupled in a heat-transferring manner to the exhaust gas path. The exhaust gas path may have an inlet region, which includes the exhaust gas inlet and has an inlet cooling capacity. The exhaust gas path may have downstream of the inlet region an intermediate region, which has an intermediate cooling capacity that is lower than the inlet cooling capacity. The exhaust gas path may have downstream of the intermediate region an outlet region, which includes the exhaust gas outlet and has an outlet cooling capacity that is greater than the intermediate cooling capacity.

### CROSS-REFERENCE TO RELATED APPLICATIONS

This application claims priority to German Patent Application No. 10 2012 205 026.4, filed Mar. 28, 2012, German Patent Application No. 10 2012 208 742.7, filed May 24, 2012, and International Patent Application No. PCT/EP2013/056542, filed Mar. 27, 2013, all of which are hereby incorporated by reference in their entireties.

### TECHNICAL FIELD

The present invention relates to an exhaust gas radiator for an exhaust gas system or for an exhaust gas recirculation system of an internal combustion engine. The invention also relates to an operating method for such an exhaust gas radiator.

### BACKGROUND

Exhaust gas radiators can be used in an exhaust gas system to remove thermal energy from the exhaust gas in order to use it elsewhere, for example to heat a coolant of a cooling circuit or to evaporate a working medium of a Rankine circuit or for heating an air stream for the air conditioning of a passenger compartment during vehicle use. An exhaust gas radiator is used in an exhaust gas recirculation system to cool the recirculated exhaust gas. Cooling of the recirculated exhaust gas increases the mass flow and reduces the combustion temperatures in the combustion chambers of the internal combustion engine, which is advantageous in terms of emissions of pollutants, in particular NOx emissions.

An exhaust gas radiator usually comprises an exhaust gas path, which leads from an exhaust gas inlet to an exhaust gas outlet, and a coolant path, which is coupled thereto in a heat-transferring manner and leads from a coolant inlet to a coolant outlet.

In heat transfer media, what is known as “fouling” occurs, which means the contamination of heat-transferring components by constituents of the coolant used. For example, algae can form in the coolant circuit, which can lead to clogging of the coolant path. In the case of exhaust gas radiators, fouling on the exhaust gas side also means the accumulation of soot. Soot entrained in the exhaust gas can accumulate on the surfaces of the exhaust gas radiator and in this manner also lead to gradual clogging of the exhaust gas path.

### SUMMARY

The present invention is concerned with the problem of specifying an improved embodiment for an exhaust gas radiator of the type mentioned in the introduction, which in particular has a reduced risk of clogging of the exhaust gas path owing to soot particles.

This problem is solved according to the invention by the subject matter of the independent claim. Advantageous embodiments form the subject matter of the dependent claims.

The invention is based on the general concept of equipping the exhaust gas radiator on the exhaust side with at least three different cooling capacity regions, which follow each other, that is, are arranged in series, in the flow direction of the exhaust gas. Accordingly, an inlet region comprises the exhaust gas inlet and is designed for an inlet cooling capacity. Downstream of the inlet region, an intermediate region is situated, which is designed for an intermediate cooling capacity. Downstream of the intermediate region, an outlet region is provided, which comprises the exhaust gas outlet and is designed for an outlet cooling capacity. The exhaust gas radiator is then designed such that the intermediate cooling capacity is lower than the inlet cooling capacity and is lower than the outlet cooling capacity. This structure according to the invention is based on the finding that the tendency for soot accumulation is comparatively low at high exhaust gas temperatures, which occur in the inlet region of the exhaust gas path. Accordingly, a comparatively high inlet cooling capacity can be realised in the inlet region. At moderate exhaust gas temperatures, however, the tendency for soot accumulation increase greatly. This can be counteracted by a reduced intermediate cooling capacity. At low exhaust gas temperatures, as occur in the outlet region of the exhaust gas path, likewise relatively great accumulations can be observed, but they adhere less and therefore can in particular be flushed out. Accordingly, a higher outlet cooling capacity can be realised again in the outlet region. The exhaust gas radiator presented here thus has, in particular inside a common housing, at least three different structured regions, which follow each other in the exhaust gas path and which make possible different heat transfer capacities owing to their different structures.

“Cooling capacity” in this case means a flow of heat from the exhaust gas in the direction of the coolant per unit time.

An embodiment is preferred in which the exhaust gas radiator has a single housing, in which the whole exhaust gas path is accommodated and which has the exhaust gas inlet and the exhaust gas outlet. The three capacity regions are thus situated inside this common housing of the exhaust gas radiator, as a result of which a particularly compact structure can be realised.

Alternatively, an embodiment is also possible in which the exhaust gas radiator has two or three housings, to which the exhaust gas path is distributed and which are series-connected to each other by means of one or two connecting pipes. The exhaust gas inlet and the exhaust gas outlet are thus situated on different housings. The inlet region and the exhaust gas inlet are expediently situated in a first housing on the inlet side, while the outlet region and the exhaust gas outlet are situated in a second housing on the outlet side. The intermediate region can then be accommodated either in the housing on the inlet side or in the housing on the outlet side or else in a central, third housing.

An embodiment is advantageous in which only one single and thus common coolant path is provided, which is routed through the at least three cooling capacity regions preferably successively, that is, in series. Likewise preferred is a flow route for the single exhaust gas path and the single coolant path using the counterflow principle. In order to be able to realise different cooling capacities with a single exhaust gas path and a single coolant path, for example the dwell times of the exhaust gas and of the coolant can vary in the individual cooling capacity regions. The surfaces available for the heat transfer can likewise be varied, e.g. by the use of heat transfer structures and the configuration thereof. The flow conditions, such as the presence of turbulent or laminar flows and/or the thickness of the boundary layers produced, can also be varied by suitable measures, such as the use of turbulators and the configuration thereof.

According to an advantageous embodiment, the exhaust gas radiator can be designed for a predefined operating state of the exhaust gas radiator such that a hydrocarbon dew point lies in the region of a transition from the inlet region to the intermediate region, while the water dew point lies in the region of a transition from the intermediate region to the outlet region. The hydrocarbons are the molecules of the respective fuel supplied to the internal combustion engine for combustion, which have not been reacted or have not been completely reacted in the respective combustion chamber. These are therefore predominantly long-chain hydrocarbons based on diesel, biodiesel, petrol, biopetrol and other, usually liquid combustible substances. This specific design of the exhaust gas radiator with regard to the three cooling capacity regions is based on the finding that water vapour and uncombusted, vaporous hydrocarbons are entrained in the exhaust gas in addition to soot. At high exhaust gas temperatures above the dew points of water and the relevant hydrocarbons, the soot accumulation is deposited comparatively little on the heat-transferring surfaces in the exhaust gas path. Accordingly, this temperature range is assigned to the inlet region with the comparatively high inlet cooling capacity. In a temperature range that lies below the dew point temperature of the hydrocarbons and above the dew point temperature of water, the soot accumulation is extremely critical, since the soot can combine with the condensing hydrocarbons to form a sticky mass that can only be removed with comparative difficulty. Accordingly, this temperature range is assigned to the intermediate region with the reduced intermediate cooling capacity. However, if the exhaust gas temperature has also fallen below the dew point of water, the condensing water can flush out the accumulating soot, so an increased cooling capacity can be realised again in this temperature range. Accordingly, this lower temperature range is assigned to the outlet region with the increased outlet cooling capacity.

The predefined operating state can for example be defined by a predefined exhaust gas volumetric flow and/or a predefined exhaust gas temperature at the exhaust gas inlet and/or a predefined coolant volumetric flow and/or a predefined coolant temperature at the coolant inlet.

According to a further advantageous embodiment, the outlet region of the exhaust gas path can then be configured to discharge condensate. As explained above, condensation of water occurs primarily in the outlet region. The condensate produced can be discharged in a targeted manner by the proposed configuration of the outlet region. The condensate can carry away flushed out soot accumulations in the process.

An embodiment in which the inlet cooling capacity is greater than the outlet cooling capacity is particularly advantageous. In this case it is taken into account that the tendency for soot formation is much lower in the inlet region than in the outlet region.

According to a particularly advantageous embodiment, the cooling capacity can be defined by the surface area available for heat transfer in the exhaust gas path. This means that said heat transfer surface is selected to be much larger in the inlet region than in the intermediate region and that the outlet region has a larger heat transfer surface than the intermediate region. The more surface area is available for heat transfer, the more surface area is also available for the accumulation of soot. If the heat transfer surface is accordingly significantly reduced in the intermediate region, there is also a much smaller surface area available to the soot carried in the exhaust gas for accumulation, which results in a reduction in soot accumulation in the intermediate region.

According to another advantageous embodiment, the cooling capacity can be defined by the density of heat transfer means in the exhaust gas path. The density of the heat transfer means is the number of heat transfer means per unit volume in the exhaust gas path. The higher the density of the heat transfer means, the greater the available heat transfer surface and the higher the cooling capacity. Applied to the exhaust gas radiator presented here, this means that the density of the heat transfer means in the inlet region is greater than in the intermediate region and is greater in the outlet region than in the intermediate region.

According to an expedient development, such heat transfer means can for example be formed by ribs and/or turbulators and/or flow obstacles, what are known as winglets, and/or by lamellae and the like, which are arranged in the exhaust gas path. Accordingly, the density of the heat transfer means or the heat transfer surface can for example be defined by the rib density, that is, by the number of ribs per unit volume in the exhaust gas path. The rib density would then be lower in the intermediate region than in the inlet region and lower than in the outlet region. In particular, it can be provided for ribs to be provided only in the inlet region and in the outlet region and for the intermediate region to be without ribs.

According to another advantageous embodiment, the cooling capacity can be defined by the cross section of the exhaust gas path through which flow can pass and/or by the flow resistance in the exhaust gas path. The flow resistance is produced by the density of the heat transfer means on the one hand and by the cross section through which flow can pass on the other. The larger the cross section through which flow can pass, the lower the flow resistance. It has been found that the tendency for soot accumulation is greatly reduced in regions with low flow resistance and a large cross section through which flow can pass. Accordingly, in the case of the exhaust gas radiator proposed here, the flow resistance in the exhaust gas path is preferably lower in the intermediate region than in the inlet region and lower than in the outlet region. Additionally or alternatively, the cross section of the exhaust gas path through which flow can pass in larger in the intermediate region than in the inlet region and than in the outlet region.

In another advantageous embodiment, the coolant path can lead from a coolant inlet to a coolant outlet, the coolant inlet being arranged at the outlet region and the coolant outlet being arranged at the inlet region, as a result of which the exhaust gas and the coolant flow through the exhaust gas radiator according to the counterflow principle. It is likewise possible for the coolant inlet to be arranged at the inlet region and the coolant outlet to be arranged at the outlet region, as a result of which exhaust gas and coolant flows through the exhaust gas radiator according to the co-flow principle. In each case the coolant path leads through all three regions of the exhaust gas path successively, that is, in series. The structural integration of the three cooling capacity regions into a single exhaust gas radiator is supported in this manner.

In another advantageous embodiment, the exhaust gas radiator can be configured as a ribbed tubular heat exchanger in which a plurality of coolant pipes extends through the exhaust gas path, which conduct the coolant on the inside and bear ribs on the outside, at least in the inlet region and in the outlet region. The different cooling capacities in the different regions of the exhaust gas path can then be changed particularly easily by varying the rib size and/or rib number and/or rib density.

In a particularly advantageous embodiment, the coolant path comprises an inlet chamber, a plurality of deflecting chambers and an outlet chamber. Overall, at least four chambers are provided, which are formed in the coolant path or along the coolant path, in particular in a common housing of the exhaust gas radiator. The common housing of the exhaust gas radiator that may be provided thus encloses the three cooling capacity regions on the side of the exhaust gas path and the above-mentioned at least four chambers on the side of the coolant path.

In a preferred embodiment, exactly four deflection chambers can be provided, so the coolant path then comprises exactly six chambers. The inlet chamber expediently has a coolant inlet and is fluid-connected to the first deflection chamber via a first group of coolant pipes, which lead through the exhaust gas path. The first deflection chamber can then be fluid-connected to the second deflection chamber via a second group of coolant pipes, which lead through the exhaust gas path. The second deflection chamber can be fluid-connected to the third deflection chamber via a third group of coolant pipes, which lead through the exhaust gas path. The third deflection chamber can be fluid-connected to the fourth deflection chamber via a fourth group of coolant pipes, which lead through the exhaust gas path. Finally, the fourth deflection chamber can be fluid-connected to the outlet chamber, which has a coolant outlet, via a fifth group of coolant pipes, which lead through the exhaust gas path. Owing to this structure, the coolant flows through the six chambers of the coolant path successively, so they form a series connection. If there is a different number of deflection chambers, there is also a correspondingly different number of groups of coolant pipes leading through the exhaust gas path.

According to an advantageous development, the coolant pipes of the first group and of the second group can run in the outlet region and the coolant pipes of the fourth group and of the fifth group can run in the inlet region (with the counterflow principle) or vice versa (with the co-flow principle). In contrast thereto, the coolant pipes of the third group run in the intermediate region.

Another embodiment proceeds from the exhaust gas radiator being configured as a bundled tubular heat exchanger, in which a plurality of exhaust gas pipes extend from the exhaust gas inlet to the exhaust gas outlet through the coolant path, conduct the exhaust gas on the inside and are exposed to the coolant on the outside. According to an advantageous development, heat transfer means can then be arranged in the exhaust gas pipes in the inlet region and in the outlet region. These heat transfer means then define the cooling capacity of the respective region of the exhaust gas path by their dimensions and/or number and/or density.

In another embodiment, flow-directing elements or flow obstacles can be arranged in the exhaust gas pipes at least in the inlet region and in the outlet region. Such flow-directing elements or flow obstacles can be realised particularly simply as “winglets” in a bundled tubular heat exchanger configured as a flat tubular heat exchanger. These are generally raised and depressed stamped portions that are produced by forming on the mutually facing longitudinal sides of the individual flat tubes. The heat transfer capacity in the exhaust gas path can be defined by the geometry and/or number and/or density and/or distribution of these winglets.

An inventive method for operating an exhaust gas radiator that has at least three regions in the exhaust gas path, namely an inlet region, an intermediate region and an outlet region, is characterised in that different cooling capacities are realised in the at least three regions, namely an inlet cooling capacity, an intermediate cooling capacity and an outlet cooling capacity, the intermediate cooling capacity being lower than the inlet cooling capacity and lower than the outlet cooling capacity.

Particularly advantageous in this case too is an embodiment in which the exhaust gas is cooled at least to a hydrocarbon dew point in the exhaust gas radiator upstream of the intermediate region and the exhaust gas is cooled at least to a water dew point in the exhaust gas radiator downstream of the intermediate region.

According to a preferred development, it can also be provided in this case for the hydrocarbon dew point to be reached in the region of a transition from the inlet region to the intermediate region and/or for the water dew point to be reached in the region of a transition from the intermediate region to the outlet region.

Further important features and advantages of the invention can be found in the subclaims, the drawings and the associated description of the figures using the drawings.

It is self-evident that the above-mentioned features and those still to be explained below can be used not only in the combination given in each case but also in other combinations or alone without departing from the scope of the present invention.

Preferred exemplary embodiments of the invention are shown in the drawings and are explained in more detail in the description below, the same reference symbols referring to the same or similar or functionally equivalent components.

### BRIEF DESCRIPTION OF THE DRAWINGS

In the figures,

FIG. 1 schematically shows a highly simplified longitudinal section through an exhaust gas radiator,

FIG. 2 schematically shows a longitudinal section as in FIG. 1, but with a different embodiment of the exhaust gas radiator,

FIG. 3 schematically shows plan views of a flat pipe of such an exhaust gas radiator in a further embodiment, in different regions a to c.

### DETAILED DESCRIPTION

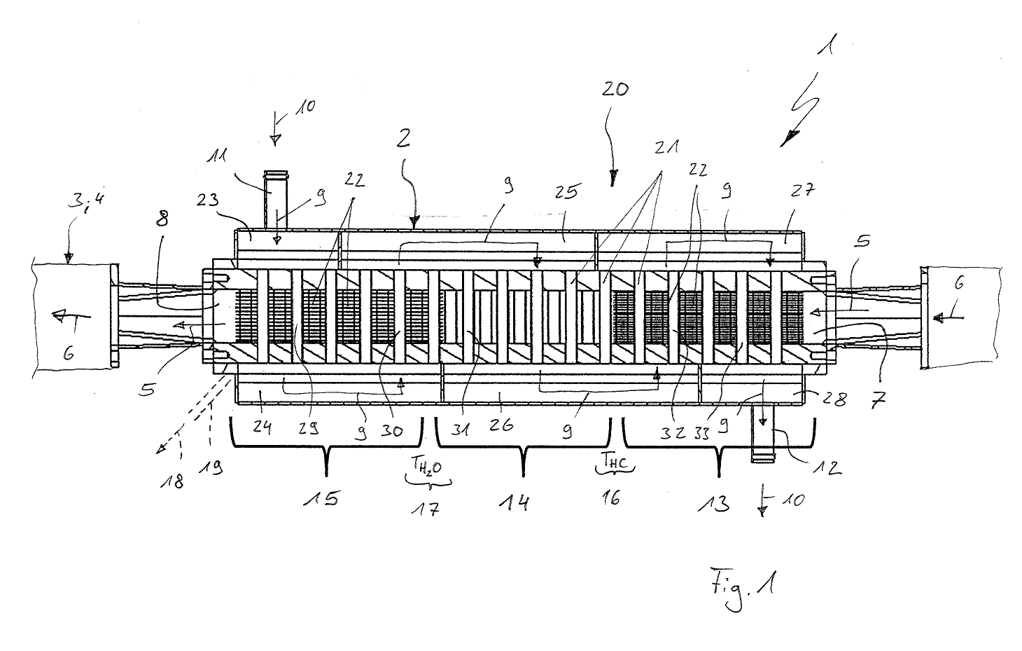

According to FIGS. 1 to 3, an exhaust gas radiator 1 comprises a housing 2, with which it can be installed into an exhaust gas system 3 or into an exhaust gas recirculation system 4 of an internal combustion engine (not shown here). The exhaust gas radiator 1 contains in its housing 2 an exhaust gas path 5, through which an exhaust gas flow 6 is conducted during operation of the exhaust gas radiator 1. The exhaust gas path 5 leads from an exhaust gas inlet 7 formed on the radiator housing 2 to an exhaust gas outlet 8 formed on the radiator housing 2. The exhaust gas radiator 1 also has in the radiator housing 2 a coolant path 9, through which a coolant flow 10 is conducted during operation of the exhaust gas radiator 1. The coolant path 9 leads from a coolant inlet 11 formed on the radiator housing 2 to a coolant outlet 12 formed on the radiator housing 2. The coolant path 9 is suitably coupled to the exhaust gas path 5 such that the media are separate and the heat is transferred.

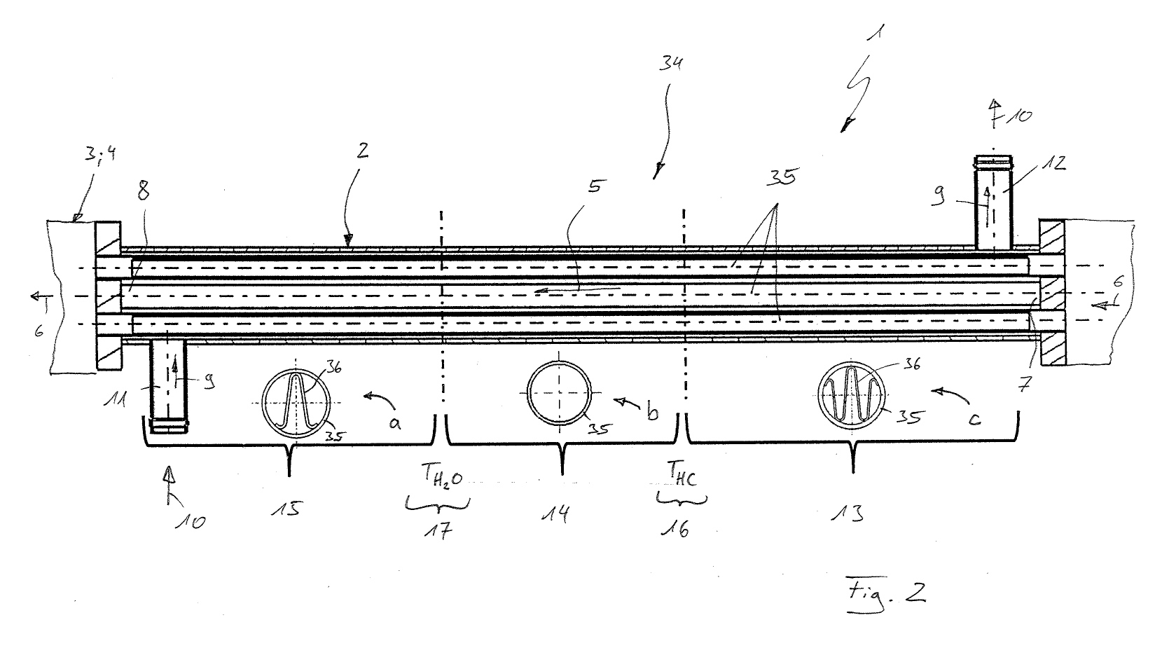

In the examples of FIGS. 1 and 2, the coolant inlet 11 is situated proximally to the exhaust gas outlet 8, while the coolant outlet 12 is arranged proximally to the exhaust gas inlet 7. Accordingly, in the embodiments shown here, a flow of the exhaust gas flow 6 and of the coolant flow 10 through the exhaust gas radiator 1 is produced according to the counterflow principle. It is clear that a through-flow according to the co-flow principle can also be realised in principle.

The exhaust gas path 5 has an inlet region 13 indicated by a curly bracket, downstream thereof an intermediate region 14 indicated by a curly bracket and downstream thereof an outlet region 15 indicated by a curly bracket. The inlet region 13 comprises the exhaust gas inlet 7. The outlet region 15 comprises the exhaust gas outlet 8. The intermediate region 14 is arranged in the flow direction of the exhaust gas between the inlet region 13 and the outlet region 15. The intermediate region 14 is thus arranged distally to the exhaust gas inlet 7 and distally to the exhaust gas outlet 8.

The inlet region 13 is designed for an inlet cooling capacity. The intermediate region 14 is designed for an intermediate cooling capacity. The outlet region 15 is designed for an outlet cooling capacity. The intermediate cooling capacity is lower than the inlet cooling capacity and lower than the outlet cooling capacity. The outlet cooling capacity is preferably also lower than the inlet cooling capacity. Accordingly, the cooling capacity in the inlet region 13 is greater than in the intermediate region 14 and greater than in the outlet region 15. However, the cooling capacity is greater in the outlet region 15 than in the intermediate region 14. The cooling capacity is lower in the intermediate region 14 than in the inlet region 14 and lower than in the outlet region 15.

For a predefined operating state of the exhaust gas radiator 1 or of the internal combustion engine equipped therewith, the exhaust gas radiator 1 is expediently designed in such a manner that a dew point of hydrocarbons T_{HC} lies in a region 16, indicated by a curly bracket, of a transition from the inlet region 13 to the intermediate region 14. The exhaust gas radiator 1 is expediently designed for the predefined operating state in such a manner that a dew point of water T_{H2O} lies in a region 17, indicated by a curly bracket, of a transition from the intermediate region 14 to the outlet region 15.

According to FIG. 1, the outlet region 15 can moreover be designed in such a manner that it is suitable for discharging condensate 18. To this end, a condensate drainage line 19 is indicated with a dashed line in FIG. 1. The condensate drainage line 19 is fluid-connected to the exhaust gas path 5.

In the embodiment shown in FIG. 1, the exhaust gas radiator 1 is configured as a ribbed tubular heat exchanger 20, which is characterised in that a plurality of coolant pipes 21 extends through the exhaust gas path 5. The coolant pipes 21 conduct the coolant on the inside and are equipped with ribs 22 on the outside, at least in the inlet region 13 and in the outlet region 15. FIG. 1 shows a rib density, that is, a number of ribs 22 per coolant pipe 21, greater than in the outlet region 15. It is also provided here for the coolant pipes 21 not to have cooling ribs 22 in the intermediate region 14. The number of ribs 22 per coolant pipe 21 defines the cooling capacity in the respective capacity region 13, 14, 15 of the exhaust gas path 5. Accordingly, the high rib density in the inlet region 13 results in a high inlet cooling capacity. The reduced rib density in the outlet region 15 results accordingly in a reduced outlet cooling capacity. The ribs 22 missing in the intermediate region 14 result accordingly in a particularly low intermediate cooling capacity.

In the embodiment shown in FIG. 1, the coolant path 9 in the radiator housing 2 comprises an inlet chamber 23, four deflection chambers 24, 25, 26, 27 and an outlet chamber 28. The deflection chambers 24, 25, 26, 27 are arranged between the inlet chamber 23 and the outlet chamber 28. The inlet chamber 23 has the coolant inlet 11. A first group 29 of coolant pipes 21 connects the inlet chamber 23 to the first deflection chamber 24. A second group 30 of coolant pipes 21 connects the first deflection chamber 24 to the second deflection chamber 25. A third group 31 of coolant pipes 21 connects the second deflection chamber 25 to the third deflection chamber 26. A fourth group 32 of coolant pipes 21 connects the third deflection chamber 26 to the fourth deflection chamber 27. Finally, a fifth group 33 of coolant pipes 21 connects the fourth deflection chamber 27 to the outlet chamber 28. With the flow through the exhaust gas radiator 1 according to the counterflow principle shown here, the coolant pipes 21 of the first group 29 and of the second group 30 are assigned to the outlet region 15. The coolant pipes 21 of the third group 31 are assigned to the intermediate region 14. The coolant pipes 21 of the fourth group 32 and of the fifth group 33 are assigned to the inlet region 13. All the coolant pipes 21 here run parallel to each other and connect the chambers 23 to 28 to each other in series.

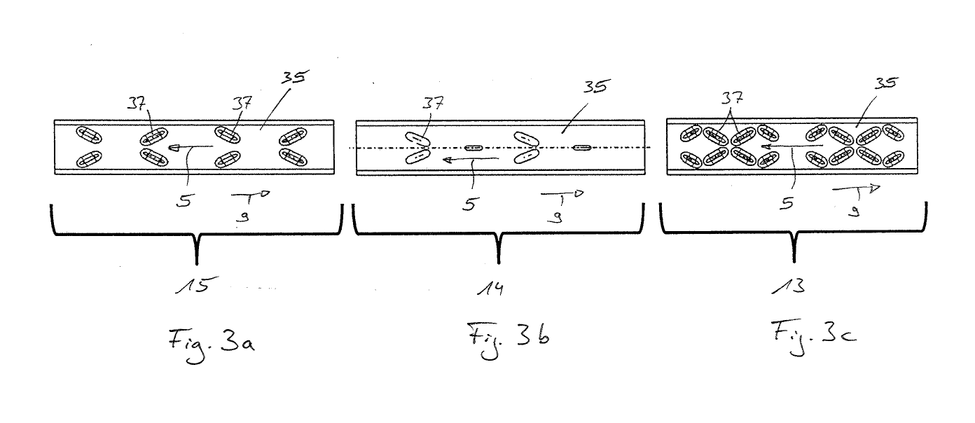

In the embodiment shown in FIG. 2, the exhaust gas radiator 1 is configured as a bundled tubular heat exchanger 34, which is characterised by a plurality of coolant pipes 35, which lead from the exhaust gas inlet 7 to the exhaust gas outlet 8 through the coolant path 9. The exhaust gas pipes 35 conduct the exhaust gas flow 6 on the inside and are exposed to the coolant flow 10 on the outside. In the example of FIG. 2, the exhaust gas pipes 35 are round pipes with circular cross sections. In contrast, in another embodiment shown in FIG. 3, the exhaust gas pipes 35 can be configured as flat pipes, which have a substantially rectangular cross section.

According to FIG. 2, heat transfer means 36 can be arranged in the exhaust gas pipes 35, at least in the inlet region 13 and outlet region 15, it being possible for said heat transfer means to be formed for example by a lamellar structure. FIG. 2 shows in each case a tubular cross section for such an exhaust gas pipe 35, said tubular cross section being referred to with a in the outlet region 15, with b in the intermediate region 14 and with c in the inlet region 15. It can be seen that such a lamellar structure 36 is arranged only in the exhaust gas pipes 35 of the inlet region 13 and of the outlet region 15, while the cross sections of the exhaust gas pipes 35 in the intermediate region 4 are free of such heat transfer means 36. It can be seen that the lamellar structure 36 in the inlet region 13 according to diagram c has a greater lamella number or density and a smaller wall thickness than the lamellar structure 36 in the outlet region 15 according to diagram a. A greater inlet cooling capacity can thus be set in the inlet region 13 than in the outlet region 15. At the same time, the outlet cooling capacity is also greater than in the intermediate region 14.

FIGS. 3a-3c each show a plan view of an exhaust gas pipe 35 configured as a flat pipe. It can be seen that these exhaust gas pipes 35 are provided with raised and depressed stamped portions that form flow-directing elements 37 or flow obstacles. The depressed stamped portions project into the exhaust-gas-conducting interior of the respective exhaust gas pipe 35. The raised stamped portions however project into the coolant path 9. In a stack of such flat pipes 35, adjacent exhaust gas pipes 35 can be supported on each other or spaced apart from each other by means of such stamped flow-directing elements 37. The heat transfer capacity in the respective capacity region of the exhaust gas path 5 can in turn be defined by the shape, number, distribution and size of the flow-directing elements 37 extending into the interior of the respective exhaust gas pipe 35. FIG. 3a shows a plan view of the exhaust gas pipe 35 in the outlet region 15. Eight flow-directing elements 37 are shown purely by way of example inside the outlet region 15. FIG. 3b shows the same exhaust gas pipe 35 inside the intermediate region 14. It can be seen that only four flow-directing elements 37 are provided here. Accordingly, the heat transfer capacity in the intermediate region 14 is reduced compared to the outlet region 15. FIG. 3c shows the same exhaust gas pipe 35 in the inlet region 13. It can be seen that sixteen flow-directing elements 37 are provided here, as a result of which the cooling capacity in the inlet region 13 is much greater than in the intermediate region 14 and than in the outlet region 15.

The manner in which the exhaust gas radiator 1 functions is explained in more detail below using FIGS. 1 and 2.

During operation of the exhaust gas radiator 1 and of the internal combustion engine equipped therewith, hot exhaust gas flows through the exhaust gas inlet 7 into the inlet region 13. The inlet region 13 is dimensioned such that the hydrocarbon dew point T_{HC} is situated at the end of the inlet region 13, that is, in the transition region 16. Since a soot accumulation is not critical or hardly takes place above the hydrocarbon dew point temperature T_{HC}, a particularly high cooling capacity can be realised here, which is realised by the large heat transfer area with the aid of the high rib density in FIG. 1 or with the aid of the high lamella density in FIG. 2. In the intermediate region 14, the exhaust gas is cooled to below the HC dew point T_{HC}, so that condensation of hydrocarbons takes place in the intermediate region 14. To largely avoid soot formation here, the cooling capacity is much reduced in the intermediate region 14. This is achieved in FIG. 1 by the absence of ribs 22 or by the use of a much reduced rib density and in FIG. 2 by the absence of a lamellar structure 36 or by the use of a much reduced lamella density. The intermediate region 14 is laid out in such a manner that the water dew point temperature T_{H2O} is reached at its end, that is, in the transition region 17. In the subsequent outlet region 15, condensation of water thus takes place, which ensures that accumulating soot can be flushed out at the same time with the aid of the condensed water. Accordingly, a higher cooling capacity can be set here again, which is realised with the aid of a corresponding rib density in FIG. 1 or lamella density in FIG. 2. The condensate that forms can optionally be collected and for example discharged via a condensate drain 19 according to FIG. 1.

The exhaust gas radiator 1 presented here can characterised in summary in that it has a cooling capacity that is adapted to the exhaust gas temperature, which decreases along the exhaust gas path 5, in such a manner that a significantly reduced cooling capacity is realised in the intermediate region 14, in which hydrocarbon condensation but no water condensation takes place. In this manner, the accumulation of soot particles can be much reduced in this intermediate region 14 in which the hydrocarbon condensation takes place, which reduces the risk of clogging and blockage of the exhaust gas path 5 in the exhaust gas radiator 1. Soot accumulation is taken into account in the outlet region 15 but can be flushed out by the water condensation.

1. An exhaust gas radiator for an exhaust gas system (3) or an exhaust gas recirculation system (4) of an internal combustion engine,
having an exhaust gas path (5), which leads from an exhaust gas inlet (7) to an exhaust gas outlet (8),
having a coolant path (9), which is coupled in a heat-transferring manner to the exhaust gas path (5),
wherein the exhaust gas path (5) has an inlet region (13), which comprises the exhaust gas inlet (7) and is designed for an inlet cooling capacity,
wherein the exhaust gas path (5) has downstream of the inlet region (13) an intermediate region (14), which is designed for an intermediate cooling capacity that is lower than the inlet cooling capacity,
wherein the exhaust gas path (5) has downstream of the intermediate region (14) an outlet region (15), which comprises the exhaust gas outlet (8) and is designed for an outlet cooling capacity that is greater than the intermediate cooling capacity.

2. The exhaust gas radiator according to claim 1,
characterised by a single housing (2), in which the entire exhaust gas path (5) is accommodated and which has the exhaust gas inlet (7) and the exhaust gas outlet (8).

3. The exhaust gas radiator according to claim 1 or 2,
characterised in that
only a single coolant path (9) is provided, which is coupled in a heat-transferring manner to the at least three regions (13, 14, 15) of the exhaust gas path (5).

4. The exhaust gas radiator according to claim 3,
characterised in that
the coolant path (9) is coupled in a heat-transferring manner to the at least three regions (13, 14, 15) of the exhaust gas path (5) successively.

5. The exhaust gas radiator according to claim 4,
characterised in that
the coolant path (9) is coupled in a heat-transferring manner in the flow direction of the coolant, first to the outlet region (15), then to the intermediate region (14) and then to the inlet region (13).

6. The exhaust gas radiator according to any one of claims 1 to 5,
characterised in that
for a predefined operating state of the exhaust gas radiator (1), which in particular has a predefined exhaust gas volumetric flow, a predefined exhaust gas temperature, a predefined coolant volumetric flow and a predefined coolant temperature, the exhaust gas radiator (1) is designed such that a hydrocarbon dew point (T_{HC}) is situated in the region of a transition (16) from the inlet region (13) to the intermediate region (14) and that a water dew point (T_{H2O}) is situated in the region of a transition (17) from the intermediate region (14) to the outlet region (15).

7. The exhaust gas radiator according to any one of claims 1 to 6,
characterised in that
the outlet region (15) of the exhaust gas path (5) is designed to discharge condensate.

8. The exhaust gas radiator according to any one of claims 1 to 7,
characterised in that
the inlet cooling capacity is greater than the outlet cooling capacity.

9. The exhaust gas radiator according to any one of claims 1 to 8,
characterised in that
the cooling capacity is defined by the surface area available for heat transfer in the exhaust gas path (5), so said surface area is lower in the intermediate region (14) than in the inlet region (13) and than in the outlet region (15).

10. The exhaust gas radiator according to any one of claims 1 to 9,
characterised in that
the cooling capacity is defined by the density of heat transfer means (22, 36) in the exhaust gas path (5), so said density is lower in the intermediate region (14) than in the inlet region (13) and than in the outlet region (15).

11. The exhaust gas radiator according to any one of claims 1 to 10,
characterised in that
the cooling capacity is defined by the cross section of the exhaust gas path (5) through which flow can pass and/or by the flow resistance in the exhaust gas path (5), so said cross section is greater in the intermediate region (14) than in the inlet region (13) and than in the outlet region (15).

12. The exhaust gas radiator according to any one of claims 1 to 11,
characterised in that
the cooling capacity is defined by the flow resistance in the exhaust gas path (5), so said flow resistance is lower in the intermediate region (14) than in the inlet region (13) and than in the outlet region (15).

13. The exhaust gas radiator according to any one of claims 1 to 12,
characterised in that
the coolant path (9) leads from a coolant inlet (11) to a coolant outlet (12), wherein the coolant inlet (11) is arranged at the outlet region (15) and the coolant outlet (12) is arranged at the inlet region (13), or vice versa.

14. The exhaust gas radiator according to any one of claims 1 to 13,
characterised in that
the exhaust gas radiator (1) is configured as a ribbed tubular heat exchanger (20) in which a plurality of coolant pipes (21) extends through the exhaust gas path (5), which conduct the coolant on the inside and bear ribs (22) on the outside, at least in the inlet region (13) and in the outlet region (15).

15. The exhaust gas radiator according to any one of claims 1 to 14,
characterised in that
the coolant path (9) has an inlet chamber (23), four deflection chambers (24, 25, 26, 27) and on outlet chamber (28),
the inlet chamber (23) has a coolant inlet (11) and is fluid-connected to the first deflection chamber (24) via a first group (29) of coolant pipes (21), which lead through the exhaust gas path (5),
the first deflection chamber (24) is fluid-connected to the second deflection chamber (25) via a second group (30) of coolant pipes (21), which lead through the exhaust gas path (5),
the second deflection chamber (25) is fluid-connected to the third deflection chamber (26) via a third group (31) of coolant pipes (21), which lead through the exhaust gas path (5),
the third deflection chamber (26) is fluid-connected to the fourth deflection chamber (27) via a fourth group (32) of coolant pipes (21), which lead through the exhaust gas path (5),
the fourth deflection chamber (27) is fluid-connected to the outlet chamber (28), which has a coolant outlet (12), via a fifth group (33) of coolant pipes (21), which lead through the exhaust gas path (5).

16. The exhaust gas radiator according to claim 15,
characterised in that
the coolant pipes (21) of the first group (29) and of the second group (30) run in the outlet region (15) and the coolant pipes (21) of the fourth group (32) and of the fifth group (33) run in the inlet region (13), or vice versa, while the coolant pipes (21) of the third group (31) run in the intermediate region (14).

17. The exhaust gas radiator according to any one of claims 1 to 13,
characterised in that
the exhaust gas radiator (1) is configured as a bundled tubular heat exchanger (34), in which a plurality of exhaust gas pipes (35) extend from the exhaust gas inlet (7) to the exhaust gas outlet (8) through the coolant path (9), conduct the exhaust gas on the inside and are exposed to the coolant on the outside.

18. The exhaust gas radiator according to claim 17,
characterised in that
heat transfer means (36) are arranged in the exhaust gas pipes (35), at least in the inlet region (13) and in the outlet region (15).

19. The exhaust gas radiator according to claim 17 or 18,
characterised in that
flow-directing elements (37) and/or flow obstacles are arranged in the exhaust gas pipes (35), at least in the inlet region (13) and in the outlet region (15).

20. A method for operating an exhaust gas radiator (1) that has an exhaust gas path (5) having an inlet region (13), an intermediate region (14) and an outlet region (15), in particular an exhaust gas radiator (1) according to any one of claims 1 to 19,
in which an inlet cooling capacity is set in the inlet region (13),
in which an intermediate cooling capacity is set in the intermediate region (14),
in which an outlet cooling capacity is set in the outlet region (15),
in which the intermediate cooling capacity is selected to be lower than the inlet cooling capacity and than the outlet cooling capacity.

21. The method according to claim 20,
characterised in that
the exhaust gas is cooled at least to a hydrocarbon dew point (T_{HC}) in the exhaust gas radiator (1) upstream of the intermediate region (14),
the exhaust gas is cooled at least to a water dew point (T_{H2O}) in the exhaust gas radiator (1) downstream of the intermediate region (14).

22. The method according to claim 21,
characterised in that
the hydrocarbon dew point (T_{HC}) is reached in the region of a transition (16) from the inlet region (13) to the intermediate region (14), and/or
the water dew point (T_{H2O}) is reached in the region of a transition (17) from the intermediate region (14) to the outlet region (15).
